(19) United States
(12) Patent Application Publication
(10) Pub. No.: US 2019/0174456 A1
(43) Pub. Date: Jun. 6, 2019

(54) Methods and Apparatus for Positioning of a Wireless Communication Device using Timing Advance Multilateration

(71) Applicant: Telefonaktiebolaget LM Ericsson (publ), Stockholm (SE)

(72) Inventors: Nicklas Johansson, Brokind (SE); John Walter Diachina, Garner, NC (US); Mårten Sundberg, Årsta (SE)

(21) Appl. No.: 16/325,457

(22) PCT Filed: Jul. 13, 2017
(86) PCT No.: PCT/SE2017/050777

§ 371 Date: Feb. 14, 2019

Related U.S. Application Data
(60) Provisional application No. 62/375,816, filed on Aug. 16, 2016.

(51) Int. Cl. H04W 64/00; G01S 5/02; G01S 5/14; H04W 74/08; H04W 56/00

(52) U.S. Cl. CPC H04W 64/003; G01S 5/0236; H04W 56/0045; H04W 74/0833; G01S 5/14

(57) ABSTRACT

A wireless communication device sends positioning messages on the random access channels in two or more cells of a wireless communication network, where the messages exhibit one or more characteristics enabling the network to differentiate them as positioning messages rather than access messages (604). Correspondingly, the network uses the received messages as a basis for estimating timing advance values for the device with respect to the two or more cells (606), and it commonly links the cell-specific timing advance values to a device identifier included in the positioning messages by the device (608). The inclusion of the device identifier allows a positioning node to recognize the timing advance values as being associated with the same wireless communication device, for use in multilateration-based positioning estimation.

### TECHNICAL FIELD

The present invention relates to wireless communication networks and particularly relates to the positioning of wireless communication devices in such networks using timing advance multilateration.

### BACKGROUND

Wireless communication networks often operate according to an underlying transmission timing structure, such as aligning all transmissions with a defined frame and sub-frame structure involving a recurring series of sequence of frames, each frame divided into a set of sub-frames. Of course, further divisions may apply, such as the sub-dividing of sub-frames into slots.

A transmitter makes transmissions aligned to the applicable frame, sub-frame, or slot boundaries. Correspondingly, a receiver aligns its reception processing according to the same applicable boundaries. However, when various wireless communication devices operating within a wireless communication network make their time-aligned transmissions towards a serving base station or another wireless access point, the received timing at the serving base station depends upon the propagation times from the respective devices. In turn, those propagation times depend on the distances between the respective devices and the involved base station.

The use of “timing advances” represents a known technique for ensuring that uplink signals transmitted from different devices all arrive at the base station in proper alignment. The base station estimates the propagation delay to each device and provides a corresponding timing advance value to the device. The device uses the timing advance value to “advance” its uplink transmission timing and, thereby, account for the propagation delay associated with the distance between the device and the base station. Providing different timing advances values to different devices being served by a given base station, where the timing advance value provided to each device matches the distance between the device and the base station, allows the base station to receive the uplink transmissions from the different devices aligned in time.

The timing advance value, therefore, indicates the distance between the device and the base station. Multiple base stations determining respective timing advance values for a given device provides a basis for determining the position or location of the device, based on jointly evaluating the distances between the device and the respective base stations, whose locations are known. The term “timing advance multilateration” or “TA multilateration” refers to the approach of estimating the position of a wireless communication device based on evaluating timing advance values determined for the device with respect to corresponding base stations in the network.

While the base multilateration idea is known, existing networks provide no convenient or efficient mechanism for the collection of multiple timing advance values, for use in multilateration processing. As one example, consider the RP-161034 document submitted for the RAN#72 meeting of the 3GPP Radio Access Network (RAN) Working Group. That document contemplates the use of a Temporary Logical Link Identity to be included by a wireless communication device in uplink radio blocks sent after the initial packet access messages used to initiate timing advance determinations by respective base stations. While the proposal offers certain advantages, setting up and using the dedicated transmission resources needed for transmission of the uplink radio blocks consumes meaningful power at the wireless communication device. Recognized herein is the need for greater signaling efficiency when collecting timing advance values for multilateration.

### SUMMARY

A wireless communication device sends positioning messages on the random access channels in two or more cells of a wireless communication network, where the messages exhibit one or more characteristics enabling the network to differentiate them as positioning messages rather than access messages. Correspondingly, the network uses the received messages as a basis for estimating timing advance values for the device with respect to the two or more cells, and it commonly links the cell-specific timing advance values to a device identifier included in the positioning messages by the device. The inclusion of the device identifier allows a positioning node to recognize the timing advance values as being associated with the same wireless communication device, for use in multilateration-based positioning estimation.

An example method of operation in a wireless communication network includes, for each of two or more cells of the network, receiving a message sent by a wireless communication device on a random access channel used for random access in the cell. Here, each cell has a corresponding cell identifier for which a positioning node is able to identify geographical coordinates, and the method further includes differentiating the received message as a positioning message rather than an access request message for which the assignment of uplink packet radio resources for transmission of higher layer payload would typically be needed. Differentiation is based on determining that the received message exhibits one or more characteristics defined for positioning messages, and the method further includes, for each cell, estimating a timing advance value for the device, based on the received message, and linking the timing advance value to the corresponding cell identifier, and to a device identifier included in the received message. The device identifier uniquely identifies the device to a positioning node, and the method correspondingly includes sending the timing advance values and the linked cell and device identifiers towards the positioning node, for use by the positioning node in calculating a position of the wireless communication device from the timing advance values. A related example involves one or more network nodes configured for operation in a wireless communication network. The one or more nodes include communication circuitry and processing circuitry. The communication circuitry is configured to receive, for each of two or more cells of the network, an access message sent by a wireless communication device on a random access channel used for random access in the cell. Each cell has a corresponding cell identifier. With respect to each cell, the processing circuitry is configured to differentiate the received message as a positioning message rather than an access request message, based on determining that the received message exhibits one or more characteristics defined for positioning messages. Further with respect to each cell, the processing circuitry is configured to estimate a timing advance value for the device, based on the received message, and link the timing advance value to the corresponding cell identifier, and to a device identifier included in the received message. As before, the device identifier uniquely identifies the device to a positioning node. Correspondingly, the processing circuitry is further configured to send the timing advance values and the linked cell and device identifiers towards the positioning node, for use by the positioning node in calculating a position of the wireless communication device from the timing advance values.

Another example involves a method at a positioning node configured for operation in a wireless communication network. The method includes sending a positioning request message towards the wireless communication device via the network and receiving two or more timing advance values from one or more nodes in the network, as determined for the device with respect to two or more cells of the network. The received timing advance values are linked to a device identifier that uniquely identifies the device to the positioning node for at least one positioning event. Correspondingly, the method further includes the positioning node determining from the linked device identifier that the two or more timing advance values are associated with the device for the at least one positioning event, and carrying out a position determination for the wireless communication device, based on the two or more timing advance values.

A positioning node in one or more examples is configured for operation in a wireless communication network and includes communication circuitry and operatively associated processing circuitry. The communication circuitry is configured for communicating with a wireless communication device via a wireless communication network that communicatively couples the positioning node to the device and the processing circuitry is configured to send a positioning request message towards the device via the network. Further, the processing circuitry is configured to receive two or more timing advance values from the network, as determined for the device with respect to two or more cells of the network. The received timing advance values are linked to a device identifier that uniquely identifies the device to the positioning node for at least one positioning event. Correspondingly, the processing circuitry is configured to determine from the linked device identifier that the two or more timing advance values are associated with the device for the at least one positioning event, and carry out a position determination for the device, based on the two or more timing advance values and the geographical coordinates of the corresponding two or more cells known by the positioning node (e.g. by data base pre-configuration).

An example wireless communication device is configured for operation in a wireless communication network and includes communication circuitry and operatively associated processing circuitry. The communication circuitry is configured for wireless communication with the network, and the processing circuitry is configured to receive a positioning request message sent from a positioning node via the network. The processing circuitry is further configured to send a message on a random access channel in each of two or more cells. The messages are sent in response to the positioning request message and each message has one or more characteristics distinguishing the message as a positioning message rather than an access request message. Each message includes a device identifier that uniquely identifies the wireless communication device to the positioning node.

Of course, the present invention is not limited to the above features and advantages. Indeed, those skilled in the art will recognize additional features and advantages upon reading the following detailed description, and upon viewing the accompanying drawings.

### BRIEF DESCRIPTION OF THE DRAWINGS

FIG. 1 is a block diagram of one embodiment of a wireless communication network.

FIG. 2 is a block diagram of one embodiment of a Base Transceiver Station (BTS).

FIG. 3 is a block diagram of one embodiment of a Base Station Controller (BSC).

FIG. 4 is a block diagram of one embodiment of a wireless communication device (WCD).

FIG. 5 is a block diagram of one embodiment of a positioning node.

FIG. 6 is a logic flow diagram of one embodiment of a method of operation at one or more network nodes in a wireless communication network.

FIG. 7 is a logic flow diagram of one embodiment of a method of operation at a wireless communication device in a wireless communication network.

FIG. 8 is a logic flow diagram of one embodiment of a method of operation at a positioning node in a wireless communication network.

FIG. 9 is a block diagram of one embodiment of processing modules implemented in one or more network nodes in a wireless communication network.

FIG. 10 is a block diagram of one embodiment of processing modules implemented in a positioning node in a wireless communication network.

FIG. 11 is a block diagram of one embodiment of processing modules implemented in a wireless communication device in a wireless communication network.

FIGS. 12 and 13 are information tables detailing example characteristics that may be used to distinguish positioning-related messages sent over a random access channel.

### DETAILED DESCRIPTION

FIG. 1 illustrates an example wireless communication network 10 (“network 10”). The network 10 provides communication services to wireless communication devices (WCDs) 12, with one such device shown for simplicity. For example, the network 10 communicatively couples the wireless communication device 12 (“device 12”) to one or more external networks 14, such as the Internet. In turn, the external network(s) 14 communicatively couple to one or more service provider (“SP”) host computers 16 in one or more service provider networks 18. The host computers 16 provide one or more types of communication services to the device 12.

The network 10 provides at least one Radio Access Network (RAN) 20 that provides an air interface for wirelessly connecting the device 12 to the network 10. In one or more embodiments, the network 10 operates according to one or more Third Generation Partnership (3GPP) standards. For example, the RAN 20 comprises a GSM/EDGE Radio Access Network (GERAN). In other embodiments, the network 10 comprises a WCDMA network, with the RAN 20 operating as a UTRAN. In still other embodiments, the network 10 comprises a Long Term Evolution (LTE) network with the RAN 20 operating as an E-UTRAN. In still other embodiments, the network 10 is configured as a Worldwide Interoperability for Microwave Access (WiMAX) network.

The RAN 20 includes one or more network nodes configured to provide radio access, with the depicted example RAN 20 including a Base Station System (BSS) 22 that includes three Base Transceiver Stations (BTSs) 24-1, 24-2, and 24-3, and an associated Base Station Controller (BSC) 26. The BTSs 24 provide corresponding coverage areas 28, e.g., the BTS 24-1 serves a coverage area 28-1, the BTS 24-2 serves a coverage area 28-2, and the BTS 24-3 serves a coverage area 28-3. The coverages areas 28-1, 28-2, and 28-3 comprise, for example, overlapping cells or sectors. In other arrangements, the BTSs 24 use directional beamforming, and the corresponding coverage areas 28 comprise directional beams. For ease of discussion, the term “cell” is used broadly.

There may be a greater or lesser number of BTSs 24 associated with the BSC 26, and there may be multiple BSCs 26 and associated BTSs 24 in the RAN 20. Thus, the device 12 may be within radio range of a multiplicity of BTSs 24 having the same or different BSC affiliations. Other node terminologies and arrangements may be used, in dependence on the telecommunication standard(s) implemented by the RAN 20. As a general proposition, the RAN 20 includes two or more transmission and reception points—e.g., multiple radio access nodes or a distributed antenna system, etc.—which provides a basis for transmitting to and/or receiving from the device 12 at two or more geographically separated points.

Such an arrangement enables the network 10 and/or the device 12 to determine the propagation delay between the device 12 and respective transmission or reception points in the network 10. In turn, knowing the propagation delays between the device 12 and two or more nodes in the network 10 having known geographic coordinates provides a basis for multilateration-based positioning of the device 12. For example, knowing the propagation delays between the device 12 and three known points in the network 10 allows the location of the device 12 to be determined using trilateration. Having a greater or lesser number of respective distances provides for more precision or less precision, respectively, when positioning the device 12.

The network 10 further includes a Core Network (CN) 30 that includes or is associated with a positioning node 32. The positioning node 32 is configured to perform multilateration-based positioning of the device 12, and for any number of other such devices 12. The CN 30 includes other nodes not shown, such as mobility management nodes, packet routing nodes, etc. Further, the device 12 may be a User Equipment (UE) within the meaning used in 3GPP technical specifications, but it should be understood broadly as comprising essentially any type of wireless communication apparatus configured for operation in the network 10. Non-limiting device examples include smartphones, feature phones, or other mobile stations or personal computing devices. Other examples include Machine Type Communication (MTC) devices, both mobile and stationary. The device 12 may be a standalone entity or may be embedded in another device, assembly, or system, such as an automobile.

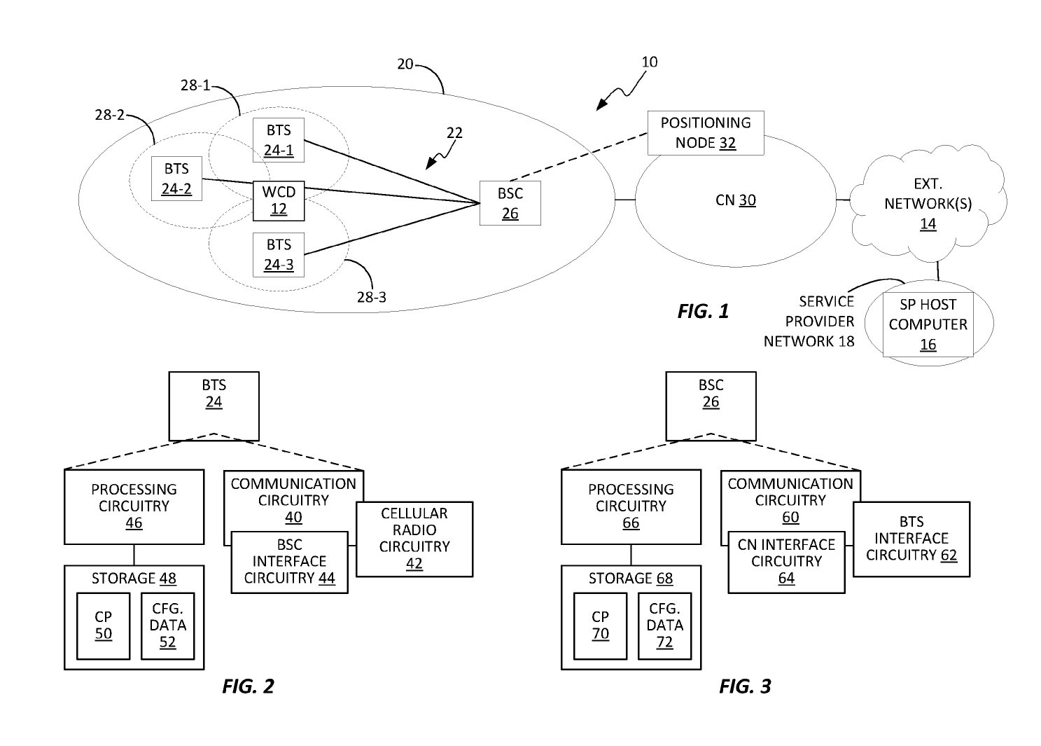

FIG. 2 illustrates an example embodiment of a BTS 24. Various elements or components constitute the BTS 24. In the example depiction, the BTS 24 includes communication circuitry 40, which may include cellular radio circuitry 42 and BSC interface circuitry 44. The cellular radio circuitry 42 provides for wireless communication with one or more devices 12 operating in a respective coverage area 28 of the BTS 24, and the BSC interface circuitry 44 provides for control and data signaling exchanges with the BSC 26.

Other entities or components in the depicted BTS 24 include processing circuitry 46, which includes or is associated with storage 48. The processing circuitry 46 comprises fixed circuitry, or preprogrammed circuitry, or programmable circuitry, or any combination of fixed, preprogrammed, and programmable circuitry. Non-limiting examples include one or more microprocessors, microcontrollers, Digital Signal Processors (DSPs), Field Programmable Gate Arrays (FPGAs), Complex Programmable Logic Devices (CPLDs), Application Specific Integrated Circuits (ASICS), or essentially any other arrangement of digital processing circuitry, such as combinational digital logic, sequential digital logic, or both.

In at least one example, the processing circuitry 46 comprises one or more processing circuits—e.g., microprocessors and supporting circuitry—that are specially adapted to perform the operations described herein, based on executing computer program instructions from one or more computer programs stored in a computer-readable medium providing non-transitory storage for the computer program(s). “Non-transitory” does not necessarily mean unchanging but does connote at least some persistence, and various types of computer-readable media may be involved, such as a mix of non-volatile memory for long-term storage of the computer program(s) and volatile memory as working memory for program execution and scratch data.

Correspondingly, in one or more embodiments, the storage 48 stores one or more computer programs 50 comprising computer program instructions the execution of which by one or more processors realizes or implements the contemplated functionality for the processing circuitry 46. The storage 48 may further store one or more items of configuration data 52, based on receiving it during live operation or based on it being pre-stored.

FIG. 3 illustrates an example embodiment of a BSC 26. Various elements or components constitute the BSC 26, including communication circuitry 60, which may include BTS interface circuitry 62 supporting communications with any associated BTS 24 and CN interface circuitry 64 supporting communications with one or more nodes in the CN 30. For example, the BSC 26 may communicate with, among other nodes, the positioning node 32.

Other entities or components in the depicted BSC 26 include processing circuitry 66, which includes or is associated with storage 68. The processing circuitry 66 comprises fixed circuitry, or preprogrammed circuitry, or programmable circuitry, or any combination of fixed, preprogrammed, and programmable circuitry. Non-limiting examples include one or more microprocessors, microcontrollers, Digital Signal Processors (DSPs), Field Programmable Gate Arrays (FPGAs), Complex Programmable Logic Devices (CPLDs), Application Specific Integrated Circuits (ASICS), or essentially any other arrangement of digital processing circuitry, such as combinational digital logic, sequential digital logic, or both.

In at least one example, the processing circuitry 66 comprises one or more processing circuits—e.g., microprocessors and supporting circuitry—that are specially adapted to perform the operations described herein based on executing computer program instructions from one or more computer programs stored in a computer-readable medium providing non-transitory storage for the computer program(s). “Non-transitory” does not necessarily mean unchanging but does connote at least some persistence, and various types of computer-readable media may be involved, such as a mix of non-volatile memory for long-term storage of the computer program(s) and volatile memory as working memory for program execution and scratch data.

Correspondingly, in one or more embodiments, the storage 68 stores one or more computer programs 70 comprising computer program instructions the execution of which by one or more processors realizes or implements the functionality contemplated for the processing circuitry 66. The storage 68 may further store one or more items of configuration data 72, based on receiving it during live operation or based on it being pre-stored.

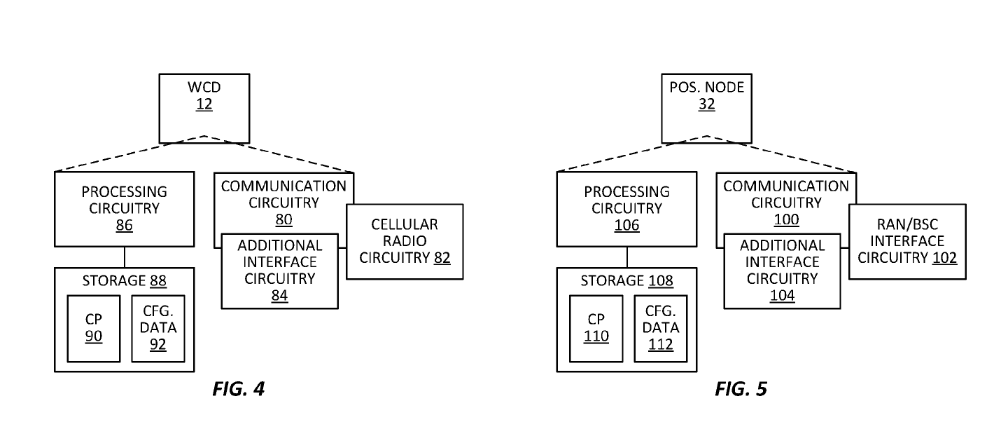

FIG. 4 illustrates an example embodiment of a wireless communication device 12, which may be a mobile station (MS) or other wireless communication apparatus configured to operate in the network 10. Various elements or components constitute the device 12, including communication circuitry 80, which may include cellular radio circuitry 82 configured to communicatively couple the device 12 to the network 10 via the air interface provided by the RAN 20. The communication circuitry 80 may further include additional interface circuitry 84, e.g., for other short-range or long-range radio interfaces, such as BLUETOOTH, WI-FI, etc.

Other entities or components in the depicted device 12 include processing circuitry 86, which includes or is associated with storage 88. The processing circuitry 86 comprises fixed circuitry, or preprogrammed circuitry, or programmable circuitry, or any combination of fixed, preprogrammed, and programmable circuitry. Non-limiting examples include one or more microprocessors, microcontrollers, Digital Signal Processors (DSPs), Field Programmable Gate Arrays (FPGAs), Complex Programmable Logic Devices (CPLDs), Application Specific Integrated Circuits (ASICS), or essentially any other arrangement of digital processing circuitry, such as combinational digital logic, sequential digital logic, or both.

In at least one example, the processing circuitry 86 comprises one or more processing circuits—e.g., microprocessors and supporting circuitry—that are specially adapted to perform the operations described herein based on executing computer program instructions from one or more computer programs stored in a computer-readable medium providing non-transitory storage for the computer program(s). “Non-transitory” does not necessarily mean unchanging but does connote at least some persistence, and various types of computer-readable media may be involved, such as a mix of non-volatile memory for long-term storage of the computer program(s) and volatile memory as working memory for program execution and scratch data. Correspondingly, in one or more embodiments, the storage 88 stores one or more computer programs 90 comprising computer program instructions the execution of which by one or more processors realizes or implements the functionality contemplated for the processing circuitry 86. The storage 88 may further store one or more items of configuration data 92, based on receiving it during live operation or based on it being pre-stored.

FIG. 5 illustrates an example embodiment of a positioning node 32. Various elements or components constitute the positioning node 32, including communication circuitry 100, which may include RAN/BSC interface circuitry 102 configured to communicatively couple the positioning node 32 to one or BSCs 26 or other RAN nodes in the network 10. The communication circuitry 100 may further include additional interface circuitry 104, e.g., for communicating with other supporting nodes in the CN 30 and/or in the external networks 14.

Other entities or components in the depicted positioning node 32 include processing circuitry 106, which includes or is associated with storage 108. The processing circuitry 106 comprises fixed circuitry, or preprogrammed circuitry, or programmable circuitry, or any combination of fixed, preprogrammed, and programmable circuitry. Non-limiting examples include one or more microprocessors, microcontrollers, Digital Signal Processors (DSPs), Field Programmable Gate Arrays (FPGAs), Complex Programmable Logic Devices (CPLDs), Application Specific Integrated Circuits (ASICS), or essentially any other arrangement of digital processing circuitry, such as combinational digital logic, sequential digital logic, or both.

In at least one example, the processing circuitry 106 comprises one or more processing circuits—e.g., microprocessors and supporting circuitry—that are specially adapted to perform the operations described herein based on executing computer program instructions from one or more computer programs stored in a computer-readable medium providing non-transitory storage for the computer program(s). “Non-transitory” does not necessarily mean unchanging but does connote at least some persistence, and various types of computer-readable media may be involved, such as a mix of non-volatile memory for long-term storage of the computer program(s) and volatile memory as working memory for program execution and scratch data.

Correspondingly, in one or more embodiments, the storage 108 stores one or more computer programs 110 comprising computer program instructions the execution of which by one or more processors realizes or implements the functionality contemplated for the processing circuitry 106. The storage 108 may further store one or more items of configuration data 112, based on receiving it during live operation or based on it being pre-stored.

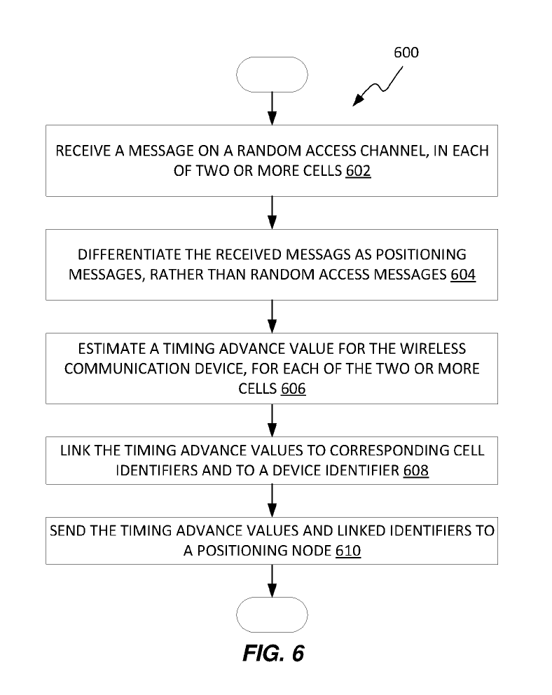

FIG. 6 depicts a method 600 of operation implemented by one or more network nodes in the network 10. The method 600 may be performed cooperatively by the radio nodes associated with the cells 28 involved in a given positioning event for a given device 12, or may be performed by a node that supervises or otherwise communications with such radio nodes. In an example relevant to FIGS. 1 and 2, a BSS 22 performs the method 600, e.g., based on the BSC 26 exchanging signaling and data with the BTSs 24 associated with the involved cells 28. Of course, further variations are possible, such as where two or more BSCs 26 cooperate.

The method 600 corresponds to one or more positioning events involving a device 12, and the method 600 may be repeated over multiple positioning events and carried out in parallel or overlapping fashion for any number of devices 12. For each of two or more cells 28 of the network 10, the method 600 includes receiving (Block 602) a message sent by a device 12 on a random access channel used for random access in the cell 28.

The method 600 further includes differentiating (Block 604) the received message for each cell 28 as a positioning message rather than an access request message. Differentiation involves determining that the received message exhibits one or more characteristics defined for positioning messages. Per-cell operations further include estimating (Bock 606) a timing advance value for the device (12) for each cell 28, based on the received message, as received in the cell 28.

Each cell 28 has a corresponding cell identifier, and the method 600 further includes linking (Block 608) the timing advance value estimated for each cell 28 to the corresponding cell identifier, and to a device identifier included in the received messages. The device identifier uniquely identifies the device 12 to a positioning node 32. Correspondingly, the method 600 includes sending (Block 610) the timing advance values and the linked cell and device identifiers towards the positioning node 32, for use by the positioning node 32 in calculating a position of the wireless communication device 12 from the timing advance values and the known geographic coordinates of the corresponding cells.

As noted, the method 600 is performed for each of one or more positioning events involving the wireless communication device 12 and may be performed likewise for any number of devices 12. In one or more embodiments, the method 600 further includes transmitting assistance information to the device 12 comprising at least one of information indicating the two or more cells 28, and information indicating the device identifier to be used for the positioning event. Consequently, the assistance information in one or more embodiments indicates to the device 12 which cells 28 should be included in the positioning event and, in turn, the device 12 sends the above-described positioning message on the random access channel in each indicated cell 28 wherein it identifies itself using the device identifier provided as part of the assistance information.

In at least one embodiment, a BSS 22 performs the method 600, with the BSS 22 comprising a BSC 26 and two or more BTSs 24 providing the two or more cells 28. In an example implementation of the method 600 in such a scenario, the step of receiving (Block 602) the message from the device 12 in each of the two or more cells 28 comprises receiving messages at the BSC 26, as received from respective ones of the two or more BTSs 24. Correspondingly, in an example of sending (Block 610) the timing advance values and their linked identifiers to the positioning node 32, the BSC 26 collects timing advance values having a same device identifier and received from the two or more BTSs 24 in conjunction with a same positioning event, and sends the collected timing advance values and the linked cell and device identifiers towards the positioning node 32.

As a further implementation example, in one or more embodiments of the method 600, the step of differentiating (Block 604) the received message—as received in each cell 28—as a positioning message rather than a normal access request message comprises determining that the received message includes an access discriminator characteristic of positioning messages sent on the random access channel, and further includes a Training Sequence Code (TSC) or a TSC time slot positioning, that is characteristic of positioning messages sent on the random access channel. Use of the random access channel provides a lightweight, efficient signaling mechanism for enabling the network 10 to estimate timing advance values for the device 12.

In particular, efficiencies arise from forming the message in a manner that (a) allows the positioning node 32 to identify the involved device 12 and (b) allows the receiving node in the RAN 20 to recognize that the message is sent on the random access channel for positioning purposes. In example embodiment, the random access channel used by the device 12 in each cell 28 comprises a Random Access Channel (RACH) or an Extended Coverage Random Access Channel (EC-RACH), as defined for a GSM/EDGE Radio Access Network (GERAN). Continuing that example, in one or more embodiments, the per-cell message received from the device 12 on the random access channel uses an 11-bit format defined for EC-RACH messages in GERAN, and a defined number of bits within the 11-bit format carry the device identifier.

In a corresponding implementation of one or more network nodes 24, 26 for carrying out the method 600 or variations of it, the one or more network nodes 24, 26 seen in FIGS. 2 and 3 include communication circuitry 40, 60. The communication circuitry 40, 60 is configured to receive, for each of two or more cells 28 of the network 10, an access message sent by a wireless communication device 12 on a random access channel used for random access in the cell 28. Each of the two or more cells 28 has a corresponding cell identifier.

The one or more network nodes 24, 26 further include processing circuitry 46, 66. For each cell 28, the processing circuitry 44, 66 is configured to differentiate the received message as a positioning message rather than an access request message. Differentiation involves determining that the received message exhibits one or more characteristics defined for positioning messages. The processing circuitry 44, 66 is further configured to estimate a timing advance value for the device 12, based on the received message; and link the timing advance value to the corresponding cell identifier, and to a device identifier included in the received message.

The device identifier uniquely identifies the device 12 to a positioning node 32. The device identifier may be unique across all cells for which the positioning node 32 provides assistance information for a given positioning event or it may be unique to each cell for which the positioning node 32 provides assistance information for a given positioning event. Correspondingly, the processing circuitry 46, 66 is further configured to send the timing advance values and the linked cell and device identifiers towards the positioning node 32, for use by the positioning node 32 in calculating a position of the device 12 from the timing advance values and the known geographic coordinates of the cells corresponding to the cell identifiers. For example, the positioning node 32 calculates the distances corresponding to the timing advance values and determines the location of the device 12 based on its distance to the respective BTSs 24 involved in the positioning event.

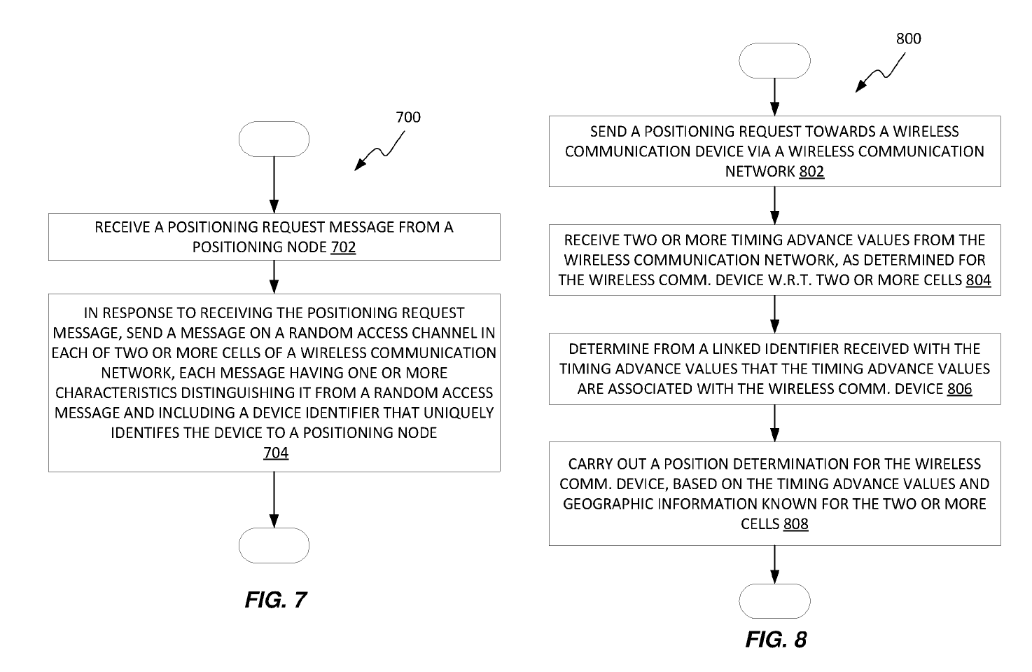

FIG. 7 depicts a method 700 of operation implemented by a wireless communication device 12 configured for operation in the network 10. The method 700 corresponds to a given positioning event and may be repeated over multiple events.

The method 700 includes the device 12 receiving a (Block 702) a positioning request message from a positioning node 32. Further, the method 700 includes, in response to the positioning request message, sending (Block 704) a message on a random access channel in each of two or more cells 28. Each message has one or more characteristics distinguishing the message as a positioning message rather than an access request message and includes a device identifier that uniquely identifies the device 12 to the positioning node 32.

The method 700 in one or more embodiments further includes one of receiving the device identifier from the positioning node 32 and obtaining the device identifier from configuration information stored in the device 12. In the same or other embodiments, the method 700 includes the device 12 determining the two or more cells 28 autonomously or receiving assistance information from the network 10 that indicates the two or more cells 28. For example, the network 10 and the device 12 may be configured such that the network 10 always tells the device 12 which cells 28 to consider in any given positioning event. In other embodiments, the device 12 follows one or more rules or default settings, e.g., based on stored configuration data, which determine which cells 28 it considers in any given positioning event. In yet other embodiments, the device 12 may use stored configuration information to select the cells 28 unless or until the network 10 provides it with a direct indication of the cells 28 to be considered in one or more positioning events.

The method 700 in one or more embodiments further includes the device 12 formatting the messages sent by it on the random access channels in each of the two or more cells 28. Particularly, the device 12 sends a random access message but configures one or more aspects of the random access message according to characteristics indicative of positioning request messages rather than access request messages. The device 12 further includes in the message a device identifier that uniquely identifies the device 12 to the involved positioning node.

The device 12 depicted in FIG. 4 may be configured to carry out the method 700 or variations of it. In a corresponding example, the communication circuitry 80 of the device 12 is configured for wireless communication with the network 10. The processing circuitry 86 is operatively associated with the communication circuitry 80 and configured to: receive a positioning request message sent from a positioning node 32 via the network 10; and in response to the positioning request message, send a message on a random access channel in each of two or more cells 28, each message having one or more characteristics distinguishing the message as a positioning message rather than an access request message and including a device identifier that uniquely identifies the device 12 to the positioning node 32.

FIG. 8 depicts a method 800 of operation implemented by a positioning node 32 configured for operation in the network 10. The method 800 corresponds to a given positioning event and may be repeated over multiple events and may be performed with respect to any number of devices 12 supported by the same or different BSSs 22 in the RAN 20.

The method 800 includes the positioning node 32 sending (Block 802) a positioning request message towards a wireless communication device 12 via the wireless communication network 10. The method 800 further includes receiving (Block 804) two or more timing advance values from one or more network nodes in the network 10, as determined for the device 12 with respect to two or more cells 28 of the network 10. The one or more network nodes providing timing advance values to the positioning node 32 are, for example, one or more BSCs 26.

The received timing advance values are linked to a device identifier that uniquely identifies the device 12 to the positioning node 32 for at least one positioning event. The timing advance values are also linked to or associated with the respective cell identifiers of the cells associated with the timing advance values. The positioning node 32 has knowledge of the geographic location of the corresponding cells. Thus, Step 804 comprises, in one or more examples, receiving two or more timing advance values determined for respective ones among two or more cells, along with the unique device identifier and the associated cell identifiers. Correspondingly, the method 800 further includes determining (Block 806) from the linked device identifier that the two or more timing advance values are associated with the device 12 for the at least one positioning event. Still further, the method 800 includes the positioning node 32 carrying (Block 808) out a position determination for the device 12, based on the two or more timing advance values and the geographic locations of the cells corresponding to the cell identifiers associated with timing advance values.

In at least one embodiment, the method 800 further includes the positioning node 32 assigning the device identifier to the device 12 on a temporary basis, from among a pool of device identifiers used by the positioning node 32 for identifying respective devices 12 involved in respective positioning events. Managing a pool of identifiers allows the positioning node 32 to temporarily assign respective ones of the identifiers to respective devices 12, either for one-time use or use over some number of positioning events. This approach allows the positioning node 32 to assign identifiers well suited for inclusion in the access messages sent by the devices 12 on the random access channels of the cells 28 involved in the positioning.

In another example implementation of the method 800, sending (Block 802) the positioning request message towards the device 12 comprises sending the positioning message request via a BSS 22 in the network 10 that is associated with the device 12. Here, the associated BSS 22 is, e.g., the currently serving BSS 22 of the device 12. Again, however, such operations are not limited to network arrangements that involve BSSs 22 and instead apply to essentially any RAN arrangement that includes geographically separated radio access nodes.

The positioning node 32 depicted in FIG. 5 may be configured to implement the method 800 or variations of it. In an example implementation, the communication circuitry 100 is configured for communicating with a wireless communication device 12 via a wireless communication network 10 that communicatively couples the positioning node 32 to the device 12. The processing circuitry 106 of the positioning node 32 is operatively associated with the communication circuitry 100 and is configured to send a positioning request message towards the device 12 via the network 10. The processing circuitry 106 is further configured to receive two or more timing advance values from the network 10, as determined for the device 12 with respect to two or more cells 28 of the network 10. The received timing advance values are linked to a device identifier that uniquely identifies the device 12 to the positioning node 32 for at least one positioning event. In turn, the processing circuitry 106 is configured to determine from the linked device identifier that the two or more timing advance values are associated with the device 12 for the at least one positioning event, and carry out a position determination for the wireless communication device 12, based on the two or more timing advance values.

Of course, other implementations or architectures may be used for the various nodes and devices described above. For example, with respect to FIGS. 2 and 3, the storage 48, 68 comprises non-transitory computer readable media storing a computer program 50, 70. The computer program 50, 70 comprises program instructions that, when executed by one or more processing circuits 46, 66 in one or more network nodes 24, 26, configure the one or more network nodes 24, 26 to receive, for each of two or more cells 28 of the network 10, an access message sent by a wireless communication device 12 on a random access channel used for random access in the cell 28. Each of the two or more cells 28 has a corresponding cell identifier.

Execution of program instructions from the computer program 50, 70 further configures the one or more network nodes 24, 26 to, for each of the two or more cells 28, differentiate the received message as a positioning message rather than an access request message. Differentiation involves determining that the received message exhibits one or more characteristics defined for positioning messages.

The computer program 50, 70 further includes program instructions configuring the one or more network nodes 24, 26 to estimate a timing advance value for the device 12 for each involved cell 28, based on the received message. Still further, the computer program 50, 70 includes program instructions the execution of which configures the one or more network nodes 24, 26 to link the timing advance value to the corresponding cell identifier, and to a device identifier included in the received message. As before, the device identifier uniquely identifies the device 12 to a positioning node 32. The computer program 50, 70 further includes program instructions that, when executed by the processing circuit(s) 46, 66, configure the network nodes 24, 26, to send the timing advance values and the linked cell and device identifiers towards the positioning node 32, for use by the positioning node 32 in calculating a position of the device 12 from the timing advance values.

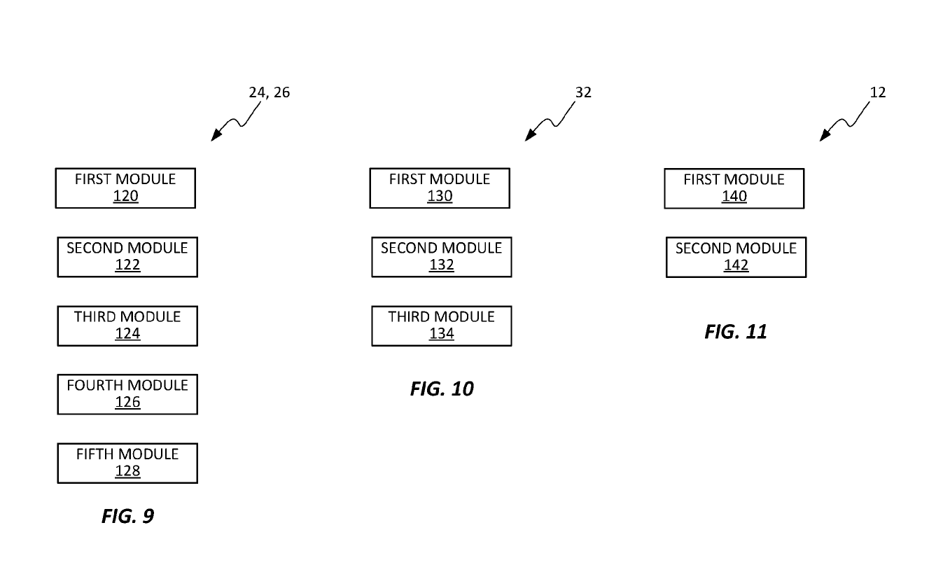

FIG. 9 further emphasizes the contemplated implementation flexibility, where the one or more network nodes 24, 26 comprise functional modules, with each module providing certain processing functionality. In an example arrangement, the one or more network nodes 24, 26 include:
a first module 120 for receiving, for each of two or more cells 28 of the wireless communication network 10, an access message sent by a wireless communication device 12 on a random access channel used for random access in the cell 28, each of the two or more cells 28 having corresponding cell identifier;
a second module for differentiating, for each of the two or more cells 28, the received message as a positioning message rather than an access request message, based on determining that the received message exhibits one or more characteristics defined for positioning messages;
a third module for estimating, for each of the two or more cells 28, a timing advance value for the device 12, based on the received message;
a fourth module for linking, for each of the two or more cells 28, the timing advance value to the corresponding cell identifier, and to a device identifier included in the received message, the device identifier uniquely identifying the device 12 to a positioning node 32; and
a fifth module for sending the timing advance values and the linked cell and device identifiers towards the positioning node 32, for use by the positioning node 32 in calculating a position of the device 12 from the timing advance values.

In a corresponding embodiment, a non-transitory computer readable medium, e.g., the storage 108 seen in FIG. 5, stores a computer program 110 comprising program instructions that, when executed by one or more processing circuits 106 of a positioning node 32 configured for operation in a wireless communication network 10, configures the positioning node 32 to send a positioning request message towards a wireless communication device 12 via a wireless communication network 10. The computer program 110 comprises further program instructions configuring positioning node 32 receive two or more timing advance values from the network 10, as determined for the device 12 with respect to two or more cells 28 of the network 10, and a cell identifier corresponding to each received timing advance value.

The received timing advance values are linked to a cell identifier and a device identifier wherein the device identifier uniquely identifies the wireless communication device 12 to the positioning node 32 for at least one positioning event. Correspondingly, the computer program includes further program instructions configuring the positioning node 32 to 1) determine from the linked device identifier that the two or more timing advance values are associated with the device for the at least one positioning event, and 2) carry out a position determination for the device 12, based on the two or more timing advance values and the geographic location of the cell associated with the cell identifier corresponding to each timing advance value.

FIG. 10 further emphasizes the contemplated implementation flexibility, where the positioning node 32 comprises, at least functionally, logical modules, with each module providing certain processing functionality. In an example arrangement, the positioning node 32 comprises:
a first module 130 for sending a positioning request message towards a wireless communication device 12 via a wireless communication network 10, and receiving two or more timing advance values from the network 10, as determined for the device 12 with respect to two or more cells 28 of the network 10;
a second module 132 for determining from the linked device identifier that the two or more timing advance values are associated with the device 12 for the at least one positioning event; and
a third module 134 for carrying out a position determination for the device 12, based on the two or more timing advance values and the geographic location of the cell associated with the cell identifier corresponding to each timing advance value.

In another embodiment, a non-transitory computer readable medium stores a computer program comprising program instructions that, when executed by one or more processing circuits of a wireless communication device 12 configured for operation in a wireless communication network 10, configures the device 12 to perform several operations. Such operations include receiving a positioning request message sent from a positioning node 32 via the network 10, and, in response to the positioning request message, send a message on a random access channel in each of two or more cells 28.

While each such message may be broadly referred to as an access message given its transmission on a random access channel, the message has one or more characteristics distinguishing it as a positioning message rather than an access request message. Each such message also includes a device identifier that uniquely identifies the device 12 to the positioning node 32. Refer to FIG. 4 for an implementation example, wherein the storage 88 serves as the computer readable medium storing a computer program 90, for execution by one or more processing circuits comprising the processing circuitry 86.

Of course, as seen in FIG. 11, the device 12 is not limited to the example architecture depicted in FIG. 4. However implemented, the device 12 in one or more embodiments includes certain functional modules, including a first module 140 for receiving a positioning request message sent from a positioning node 32 via the network 10. Additionally, the device 12 includes a second module 142 for, in response to the positioning request message, sending a message on a random access channel in each of two or more cells 28. Each message has one or more characteristics distinguishing the message as a positioning message rather than an access request message and including a device identifier that uniquely identifies the device 12 to the positioning node 32.

With the above examples in mind, the methods and apparatus detailed herein provide for power efficient collection of timing advance values. Power efficiency comes via a new procedure wherein a wireless communication device 12 operating in a wireless communication network 10 uses an assigned temporary identifier to identify itself to a positioning node 32 and transmits a unique access message on the random access channels of the cells 28 involved in a given multilateration-based positioning event. The power efficiency is realized by limiting the requirements imposed on the wireless communication device 12 to sending an access message on the random access channels of the cells 28 involved in a given multilateration-based positioning event. That is, the disclosed technique does not require the wireless communication device 12, after sending an access message on the random access channel, to receive a subsequent uplink packet resource assignment message for sending additional information to the wireless communication network 10. In one or more embodiments, the network 10 internally collects the timing advance values associated with the temporary device identifier. In other embodiments, the device 12 is configured to collect and reports the timing advance values. In such cases, the network 10 may use a dedicated downlink message to provide the estimated timing advance values to the device 12.

Among its several advantages, the technique contemplated herein improves accuracy when determining the position of a device 12 and it reduces the number of uplink messages needed at the device 12. For example, no dedicated or shared uplink channels are needed, because the device 12 sends an access message on a random access channel in each cell 28 involved in a positioning event. The message includes a device identifier that uniquely identifies the device 12 to the positioning node 32, which allows all of the timing advance values to be associated together with the device 12. Further, the message is structured in such a way, or includes certain information, such that the network 10 reliably recognizes that the message is being sent for positioning purposes. Reducing the number of transmissions needed from the device 12 to carry out multilateration-based positioning decreases power consumption at the device 12.

To associate the timing advance values determined in a positioning event for different cells 28 with a given device 12, the device 12 needs to use a sufficiently unique identity at initial access for the network 10 to distinguish its access from that of other devices 12. This usage allows the network 10 to associate the timing advance values determined for the cells 28 with the same device identifier. The network 10 can then compile the list of timing advance values and linked cell identifiers, along with the commonly linked device identifier, and send it along to the positioning node 32. Alternatively, the network 10 can echo the timing advance values back to the device 12, and the device 12 compiles and sends the list to the positioning node 32.

In one example, the RAN 20 is a GERAN and the identity is assigned by a serving BSS 22 of the device 12, or at least is provided to the device 12 via the BSS 22. For example, it may be assigned by the positioning node 32 and then communicated to the device 12 via the BSS 22. The positioning node 32 in one or more embodiments comprises a Serving Mobile Location Center (SMLC), as used in GERAN. In other embodiments, the device 12 determines the device identifier to be used for a given one or more positioning events, e.g., based on random selection. In all cases, the longer the identity, the lower the risk is that the timing advance values are associated with the wrong device 12.

While the following details and those immediately above refer to the BSS 22, it will be understood that other types of networks, e.g., non-GERAN networks, may use other types of nodes for the same or similar processing. In any case, a first method where the BSS 22 collects the timing advance values has the advantage that the device 12 only needs to synchronize to and send an access message in each of the cells 28 to be used in the positioning procedure. It is then the responsibility of the network 10 to collect timing advance values in each of the cells 28.

More precisely, in an example implementation, the contemplated operations include:

1. The device 12 either autonomously determines, or is provided with from the network 10, a list of cells 28 with which timing advance values need to be associated.

2. Then for each cell in the list: the device 12 reselects to the cell 28 and transmits a packet access message containing the unique identity, and the associated BSS 22 receives and estimates the timing advance value of the packet access message containing the unique device identifier.

3. The list of cells and associated timing advance values are then collected by the BSS 22 and forwarded to the node responsible for performing the positioning estimation. The second method involves the device 12 collecting and reporting the timing advance values and has the advantage that the BSS 22 does not have to be configured to collect timing advance values in different cells 28 for the contemplated multilateration-based positioning. In case the device 12 determines the list of cells 28 to be part of the positioning procedure, the drawback is that the BSS 22 is not aware of how many and in which cells to collect timing advance values unless the device 12 communication that information to the BSS 22.

In an embodiment where the device 12 collects and reports the timing advance values to be used for multilateration-based positioning, the following steps represent an example implementation:

1. The device 12 either autonomously determines, or is provided with from the network 10, a list of cells 28 with which timing advance values needs to be associated.

2. Then for each cell in the list: the device 12 reselects to the cell 28 and transmits a packet access message containing the unique identity, the BSS 22 receives and estimates the timing advance value of the packet access message containing the unique identity, the BSS 22 sends a downlink message to the device 12 containing the unique identity of the device 12 as well as the estimated timing advance value (e.g., using the common control channels, and the device 12 receives the downlink message containing the unique identity and associates the cell 28 with the estimated timing advance value.

3. The list of cells 28 and associated timing advance values are then collected and sent by the device 12 to the node responsible for carrying out the positioning estimation, e.g., the positioning node 32.

The cell identifiers also need to be unique for a correct positioning procedure to take place. The larger the cell identifier the smaller the risk for two cells having the same identifier. However, longer identifiers also mean that more information needs to be transmitted over the radio interface, impacting the battery lifetime of the device 12, and the capacity of the network 10. Examples of cell identifiers that can be used for positioning include the Base Station

Identification Code (BSIC), the BSIC combined with the Broadcast Control CHannel (BCCH) frequency of the cell (absolute radio-frequency channel number, i.e., ARFCN), a unique cell identifier sent in System Information broadcasted for the cell 28, and an index pointing to the neighbor cell list broadcast in the System Information messages.

When accessing the network 10, the device 12 needs to indicate to the network 10, for example when making the access on the Random Access CHannel (RACH), that the access is intended to be a positioning request, for the network 10 to act accordingly. This indication can be done for example by: the use of a training sequence code (TSC) unique to making a positioning request on that specific physical resource, a message type identifier or a message discriminator included in the message body, a unique channel coding procedure (for example by the use of a specific cyclic redundancy check (CRC) code) that will assist the receiving node in the network 10 in identifying the message as being positioning related rather than a normal access message, or any combination of the foregoing approaches.

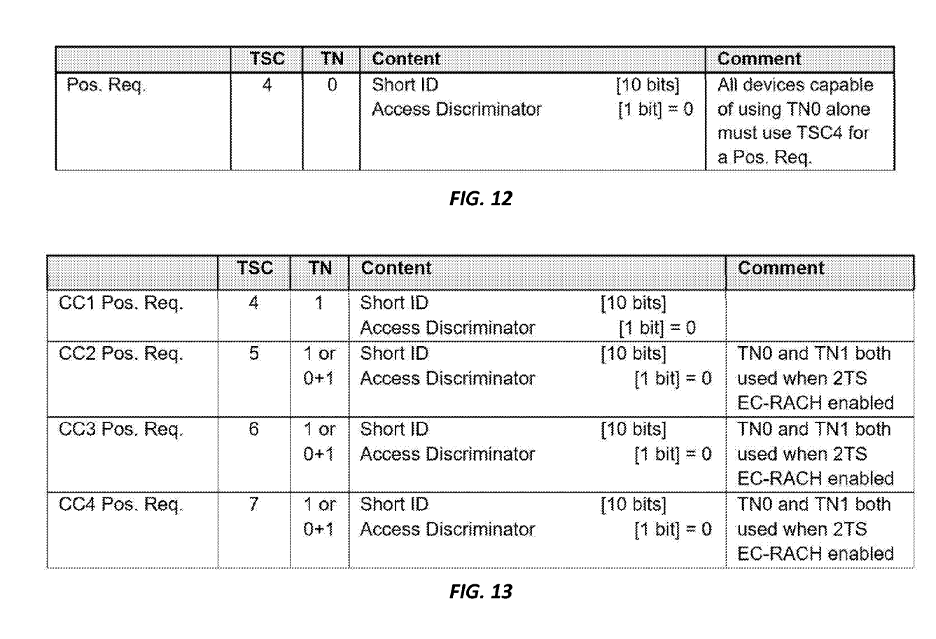

In one embodiment applicable to GSM/EDGE, the message to transmit when making a Multilateration Access (Positioning Request) comprises a Short ID and an Access Discriminator bit that together form an 11-bit access request message sent on the RACH or the Extended Coverage-RACH (EC-RACH). In an example, the contemplated positioning message is structured as:

<Positioning request message content>::=
<Short ID: bit (10)>
<Discriminator: bit (1)==L>;
   Further in the GERAN/EDGE context, the TSC and timeslot number (TN) combinations used in conjunction with a Multilateration Access can be seen in FIGS. 12 and 13.

An example device 12 is configured, e.g., via execution of stored program code, to perform certain steps, including:
determining or accessing/receiving a list of cells 28 to be used for a positioning event;
selecting or reselecting to each cell 28 in the list of cells and transmitting a packet access message on the random access channel, where the message includes a device identifier that is uniquely associated with the device 12, at least temporarily and further includes a TSC, a specific Cyclic Redundancy Check (CRC) code, and/or other indicator or information that is characteristic of positioning-related access messages sent over the random access channel;
receiving from the cell 28—i.e., from the currently selected cell 28 among the list of cells 28—a timing advance value;
compiling the timing advance values and the cell IDs into a compiled list that includes the device identifier; and
sending the compiled list to the network 10, e.g., directly or indirectly sending the compiled list to the positioning node 32.

In other embodiments, one or more nodes in the network 10 are configured to compile a list of timing advance values determined for a given positioning event, including the respective cell IDs of the involved cells and the device identifier of the involved device 12.

Notably, modifications and other embodiments of the disclosed invention(s) will come to mind to one skilled in the art having the benefit of the teachings presented in the foregoing descriptions and the associated drawings. Therefore, it is to be understood that the invention(s) is/are not to be limited to the specific embodiments disclosed and that modifications and other embodiments are intended to be included within the scope of this disclosure. Although specific terms may be employed herein, they are used in a generic and descriptive sense only and not for purposes of limitation.

1-36. (canceled)

37. A method of operation in a wireless communication network, the method comprising:
for each of two or more cells of the wireless communication network:
receiving a message sent by a wireless communication device on a random access channel used for random access in the cell, each cell having a corresponding cell identifier;
differentiating the received message as a positioning message rather than an access request message, based on determining that the received message exhibits one or more characteristics defined for positioning messages;
estimating a timing advance value for the wireless communication device, based on the received message; and
linking the timing advance value to the corresponding cell identifier, and to a device identifier included in the received message, said device identifier uniquely identifying the wireless communication device to a positioning node; and
sending the timing advance values and the linked cell and device identifiers towards the positioning node, for use by the positioning node in calculating a position of the wireless communication device from the timing advance values and linked cell identifiers.

38. The method of claim 37, wherein the method is performed for each of one or more positioning events involving the wireless communication device.

39. One or more network nodes configured for operation in a wireless communication network, the one or more network nodes comprising:
communication circuitry configured to receive, for each of two or more cells of the wireless communication network, an access message sent by a wireless communication device on a random access channel used for random access in the cell, each of the two or more cells having corresponding cell identifier; and
processing circuitry configured to, for each of the two or more cells:
differentiate the received message as a positioning message rather than an access request message, based on determining that the received message exhibits one or more characteristics defined for positioning messages;
estimate a timing advance value for the wireless communication device, based on the received message; and
link the timing advance value to the corresponding cell identifier, and to a device identifier included in the received message, said device identifier uniquely identifying the wireless communication device to a positioning node;
said processing circuitry being further configured to send the timing advance values and the linked cell and device identifiers towards the positioning node, for use by the positioning node in calculating a position of the wireless communication device from the timing advance values and linked cell identifiers.

40. The one or more network nodes of claim 39, wherein the one or more network nodes are configured to send the received messages and the linked identifiers for each of one or more positioning events involving the wireless communication device towards the positioning node.

41. The one or more network nodes of claim 39, wherein the one or more network nodes are configured to transmit assistance information to the wireless communication device in a positioning request message prior to reception of the messages sent by the wireless communication device on a random access channel in two or more cells, comprising at least one of:
information indicating the two or more cells; and
information indicating the device identifier.

42. The one or more network nodes of claim 39, wherein the one or more network nodes comprise a Base Station System (BSS) that includes a Base Station Controller (BSC) and two or more Base Transceiver Stations (BTSs), providing the two or more cells, and wherein the BTSs are configured to receive the messages in respective ones of the two or more cells, and the BSC is configured to receive the messages from the BTSs.

43. The one or more network nodes of claim 42, wherein the one or more network nodes are configured to send the timing advance values and their linked identifiers, based on collecting timing advance values having a same device identifier and received from the two or more BTSs in conjunction with a same positioning event, and sending the collected timing advance values and the linked cell and device identifiers towards the positioning node.

44. The one or more network nodes of claim 39, wherein the processing circuitry is configured to differentiate the received message as a positioning message rather than an access request message, based on determining that the received message includes an access discriminator characteristic of positioning messages sent on the random access channel, and further includes a Training Sequence Code (TSC) that is characteristic of positioning messages sent on the random access channel.

45. The one or more network nodes of claim 39, wherein the random access channel comprises a Random Access Channel (RACH) or an Extended Coverage Random Access Channel (EC-RACH), as defined for a GSM/EDGE Radio Access Network (GERAN).

46. The one or more network nodes of claim 45, wherein the received message uses an 11-bit format defined for EC-RACH messages in GERAN, and wherein a defined number of bits within the 11-bit format carry the device identifier.

47. A method of operation at a wireless communication device configured for operation in a wireless communication network, the method comprising:
receiving a positioning request message from a positioning node; and
in response to the positioning request message, sending a message on a random access channel in each of two or more cells, each message having one or more characteristics distinguishing the message as a positioning message rather than an access request message and including a device identifier that uniquely identifies the wireless communication device to the positioning node.

48. A wireless communication device configured for operation in a wireless communication network, the wireless communication device comprising:
communication circuitry configured for wireless communication with the wireless communication network; and
processing circuitry operatively associated with the communication circuitry and configured to:
receive a positioning request message sent from a positioning node via the wireless communication network; and
in response to the positioning request message, send a message on a random access channel in each of two or more cells, each message having one or more characteristics distinguishing the message as a positioning message rather than an access request message and including a device identifier that uniquely identifies the wireless communication device to the positioning node.

49. The wireless communication device of claim 48, wherein the processing circuitry is further configured to: receive the device identifier from the positioning node in a positioning request message or obtain the device identifier from configuration information stored in the wireless communication device.

50. The wireless communication device of claim 48, the processing circuitry is configured to: determine the two or more cells autonomously, or receive assistance information from the wireless communication network in a positioning request message that indicates the two or more cells.

51. The wireless communication device of claim 48, wherein the processing circuitry is configured to format the messages sent on the random access channels in each of the two or more cells as a random access message, except for configuring one or more aspects of the random access message according to characteristics indicative of positioning request messages rather than access request messages.

52. A method at a positioning node configured for operation in a wireless communication network, the method comprising:
sending a positioning request towards the wireless communication device via the wireless communication network;
receiving two or more timing advance values from one or more nodes in the wireless communication network, as determined for the wireless communication device with respect to two or more cells of the wireless communication network, said received timing advance values linked to cell identifiers of the two or more cells and a device identifier that uniquely identifies the wireless communication device to the positioning node for at least one positioning event; and
determining from the linked device identifier that the two or more timing advance values are associated with the wireless communication device for the at least one positioning event; and
carrying out a position determination for the wireless communication device, based on the two or more timing advance values.

53. The method of claim 52, further comprising assigning the device identifier to the wireless communication device on a temporary basis, from among a pool of device identifiers used by the positioning node for identifying respective wireless communication devices involved in respective positioning events.

54. A positioning node configured for operation in a wireless communication network, the positioning node comprising:
communication circuitry configured for communicating with a wireless communication device via a wireless communication network that communicatively couples the positioning node to the wireless communication device; and
processing circuitry operatively associated with the communication circuitry and configured to:
send a positioning request towards the wireless communication device via the wireless communication network;
receive two or more timing advance values from the wireless communication network, as determined for the wireless communication device with respect to two or more cells of the wireless communication network, said received timing advance values linked to cell identifiers for the two or more cells and a device identifier that uniquely identifies the wireless communication device to the positioning node for at least one positioning event;
determine from the linked device identifier that the two or more timing advance values are associated with the wireless communication device for the at least one positioning event; and
carry out a position determination for the wireless communication device, based on the two or more timing advance values.

55. The positioning node of claim 54, wherein the processing circuitry is configured to assign the device identifier to the wireless communication device on a temporary basis, from among a pool of device identifiers used by the positioning node for identifying respective wireless communication devices involved in respective positioning events.

56. The positioning node of claim 54, wherein the processing circuitry is configured to send the positioning request message towards the wireless communication device via a Base Station System (BSS) in the wireless communication network that is associated with the wireless communication device.
